(19) United States
(12) Patent Application Publication
(10) Pub. No.: US 2006/0192313 A1
(43) Pub. Date: Aug. 31, 2006

(54) Method for making a shoe sole component

(76) Inventor: Chiang Yung Shen, Taichung (TW)

Correspondence Address: CHARLES E. BAXLEY, ESQ., 90 JOHN STREET, THIRD FLOOR, NEW YORK, NY, 10038, US

(21) Appl. No.: 11/067,996

(22) Filed: Feb. 28, 2005

(51) Int. Cl. B29C 44/04; B29D 31/50

(52) U.S. Cl. 264/45.1; 264/244

(57) ABSTRACT

A method for making a shoe sole component in accordance with the present invention comprises the following steps: preparing raw materials; prilling the raw materials into particles; preparing the mould; ejection-forming the outer layer of the sole; blow-forming the outer layer of the sole; taking out the formed sole. The sole obtained by the method of the present invention will have two densities, two hardness and two colors.

### BACKGROUND OF THE INVENTION

1. Field of the Invention

The present invention relates to a method for making a shoe sole component.

2. Description of the Prior Arts

A shoe generally consists of three basic components: an upper, an insole and a sole, each of which has its own weight and manufacturing method.

For example, FIGS. 1 and 2 show a conventional method of manufacturing the sole 10, which comprises the following steps: preparing raw materials 11, prilling the raw materials 12 into particles, preparing the mould 13, ejecting mixed raw material into the mould 14 and taking out the sole 15. The raw materials used in the steps of preparing raw materials 11, prilling the raw materials 12 into particles and ejecting mixed raw material into the mould 14 is Thermo Plastic Rubber (TPR) added with a small amount of foaming agents. However, the sole 10 made by this conventional method is not only heavy in weight, but also its production speed is very slow, thus relatively increasing the production cost.

Although a lightweight sole also can be made by using Polyurethane Resin (PU) as a raw material, the required cooling off time of this conventional method will be long, so that the idle time of the mould is over long and the production capacity is relatively decreased. Furthermore, this conventional sole 10 is not recyclable and has poor antiskid performance, and air bubbles will appear on the sole surface.

In addition, despite the weight and the antiskid performance of the sole can be improved if using Ethylene Vinyl Acetate (EVA) as raw material, the defects of slow production speed, high cost, air bubbles and not recyclable will still exist.

If using Thermoplastic Rubber (TR) as raw material, the sole will still have the defects of slow production speed, high cost and air bubbles.

The present invention has arisen to mitigate and/or obviate the afore-described disadvantages.

### SUMMARY OF THE INVENTION

The primary objective of the present invention is to provide a method for making a shoe sole component, which is capable of substantially reducing the weight of the shoe sole.

The secondary objective of the present invention is to provide a method for making a shoe sole component which is capable improve the production speed while saving the production cost.

Another important objective of the present invention is to provide a method for making a shoe sole component which can improve the appearance of the shoe sole by preventing the air bubbles being caused on the surface of the shoe sole.

A method for making a shoe sole provided in accordance with the present invention comprises the following steps:

preparing raw materials: mixing two different materials of TPR and TR together;

prilling the raw materials: prilling the mixture of TPR and TR into particles by using prilling machine, and oven-drying the particles at 35-65 degrees Celsius;

preparing mould: preparing a mould consisted of an upper portion, a lower portion and a mid spacer, the mould further comprising feeding, blowing, air-adjusting and material-adjusting structures;

ejection-forming an outer layer of a shoe sole: closing the mid spacer to the lower portion of the mould, melting the material of TR by using ejection-molding machine, and then ejecting the TR into a cavity formed by the lower portion of the mould and the mid spacer at 140-180 degrees Celsius;

blow-forming an inner layer of the shoe sole: turning the mid spacer up so as to close the upper portion of the mould to the lower portion, melting the material of TPR by using blowing machine, and ejecting the TPR, at 170-180 degrees Celsius, into a cavity formed by the upper and the lower portions of the mould, meanwhile, blowing air into the cavity so as to foam the TPR, reducing the weight, so that the foamed TPR will fully occupy the whole space of the cavity and will be combined with the TR;

taking out the shoe sole: separating the upper and the lower portions of the mould from each other to take out the shoe sole, cooling it down and trimming periphery of the shoe sole, thus a finished sole is obtained.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows the steps of a conventional method of making a shoe sole;

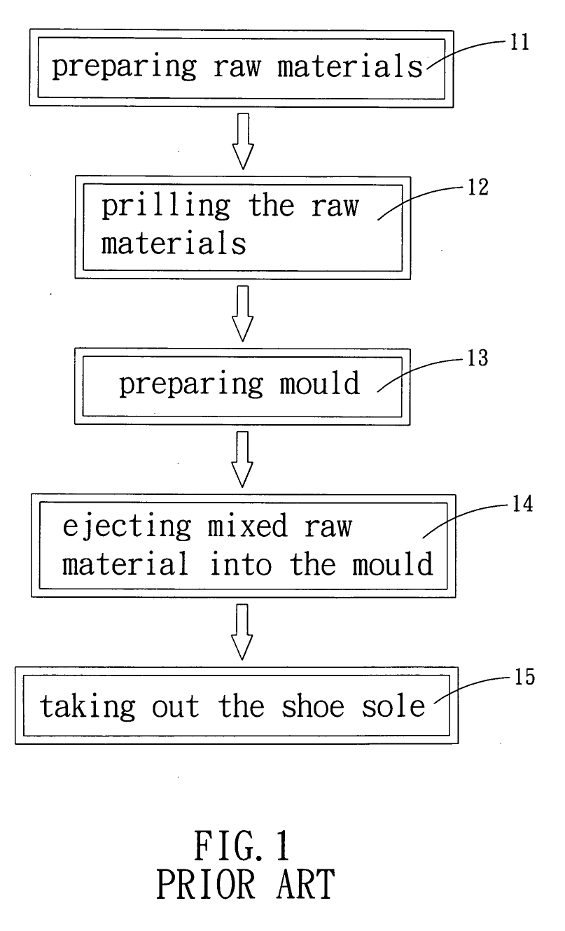

FIG. 2 is cross sectional view of a conventional shoe sole;

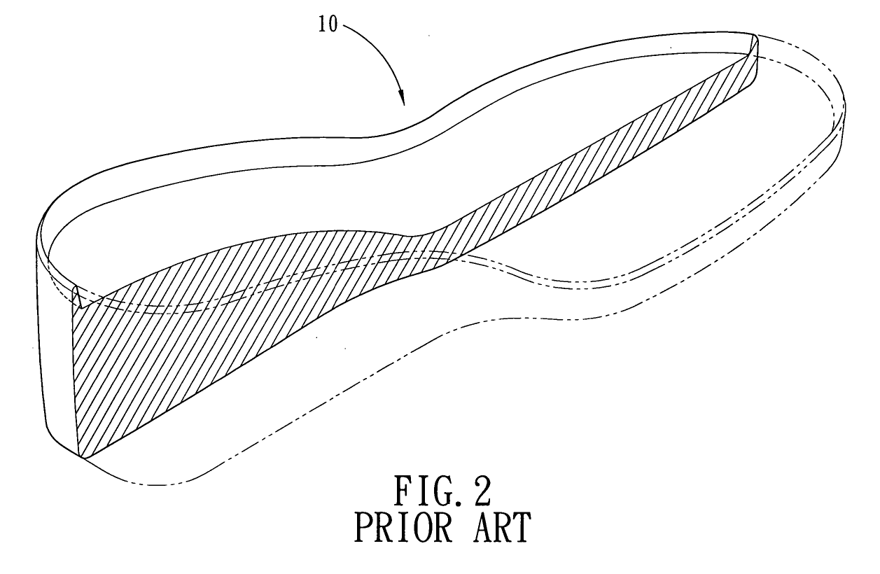

FIG. 3 shows the steps of a method of making a shoe sole component in accordance with the present invention;

FIG. 4 is a cross sectional view of a shoe sole made method in accordance with the present invention.

### DETAILED DESCRIPTION OF THE PREFERRED EMBODIMENT

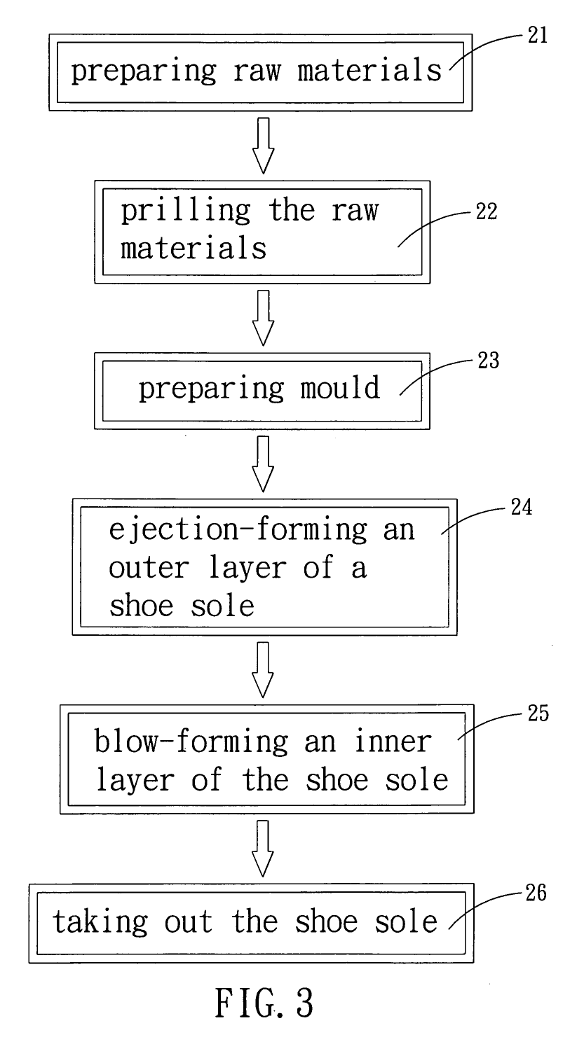

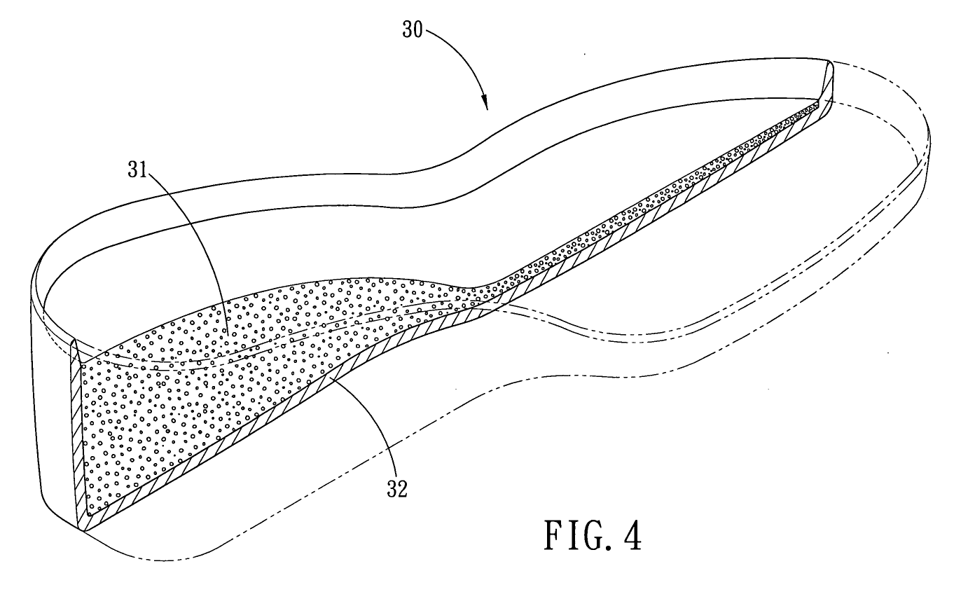

Referring to FIGS. 3 and 4, a method for making a shoe sole component in accordance with the present invention is shown and comprises the following steps: 21, preparing raw materials; 22, prilling the raw materials into particles; 23, preparing the mould; 24, ejection-forming the outer layer of the sole; 25, blow-forming the outer layer of the sole; 26 taking out the formed sole.

The step 21 of preparing raw materials is to mix two different materials of TPR and TR together, wherein the material TRP is used to form the inner layer 31 of the sole 30, while the TR is used to form the outer layer 32 of the sole 30.

The step 22 of prilling the raw materials serves to prill the mixture of TPR and TR into particles by using prilling machine, and then the particles are oven-dried at 35-65 degrees Celsius, wherein the dried TRP is used to form the inner layer 31 of the sole 30, while the dried TR is used to form the outer layer 32 of the sole 30.

The step 23 of preparing mould involves preparing precision casting mould which is resistant to high pressure and high temperature, the mould includes an upper portion, a lower portion, a mid spacer and air tight equipments. When the upper and the lower portions are closed, the cavity of the lower portion of the mould will be vacuumized, and the mould also comprises feeding, blowing, air-adjusting and material-adjusting structures.

The step 24 of ejection-forming the outer layer of the sole involves: closing the mid spacer to the lower portion of the mould, melting the material of TR by using ejection-molding machine, and then ejecting the TR into the cavity formed by the lower portion of the mould and the mid spacer at 140-180 degrees Celsius, so that the outer layer 32 of the sole 30 can be formed.

The step 25 of blow-forming the inner layer of the sole includes: turning the mid spacer up so as to close the upper portion of the mould to the lower portion, melting the material of TPR by using blowing machine, and ejecting the TPR into the cavity formed by the upper and the lower portions of the mould at 170-180 degrees Celsius, meanwhile, blowing air into the cavity so as to foam the TPR, reducing the weight, so that the foamed TPR will fully occupy the whole space of the cavity and will be combined with the TR. Consequently, the inner layer 31 of the sole 30 and the outer layer 32 combined with the inner layer 31 are formed.

The step 26 of taking out the formed sole involves: separating the upper and the lower portions of the mould from each other to take the sole out, cooling it down and trimming the periphery of the sole, thus a finished sole 30 is obtained.

Therefore, the sole 30 in accordance with the present invention has two layers, the outer layer 32 and the inner layer 31. The outer layer 32 is ejection formed by TR, so that it is wearable and has an optimized density, any patterns and grains can be formed on the surface of the outer layer 32 without causing air bubbles. The inner layer 31 of the sole 30 will be lightweight since it is blowing-formed by TPR material. As a result, the sole 30 obtained by the method of the present invention will have two densities, two hardness and two colors, highly improving the wearing comfort while reducing the weight. On the other hand, the method of the present invention can improve the production speed, accordingly saving the production cost.

It is to be noted that the mould used in the present invention is precision casting mould, so that the grains and the patterns in the mould cavities can be more truly and clearly transferred onto the surface of the shoe sole.

While we have shown and described various embodiments in accordance with the present invention, it should be clear to those skilled in the art that further embodiments may be made without departing from the scope of the present invention.

What is claimed is:

1. A method for making a shoe sole component comprising:
preparing raw materials: mixing two different materials of TPR and TR together;
prilling the raw materials: prilling the mixture of TPR and TR into particles by using prilling machine, and oven-drying the particles at 35-65 degrees Celsius;
preparing mould: preparing a mould consisted of an upper portion, a lower portion and a mid spacer, the mould further comprising feeding, blowing, air-adjusting and material-adjusting structures;
ejection-forming an outer layer of a shoe sole: closing the mid spacer to the lower portion of the mould, melting the material of TR by using ejection-molding machine, and then ejecting the TR into a cavity formed by the lower portion of the mould and the mid spacer at 140-180 degrees Celsius;
blow-forming an inner layer of the shoe sole: turning the mid spacer up so as to close the upper portion of the mould to the lower portion, melting the material of TPR by using blowing machine, and ejecting the TPR, at 170-180 degrees Celsius, into a cavity formed by the upper and the lower portions of the mould, meanwhile, blowing air into the cavity so as to foam the TPR, reducing the weight, so that the foamed TPR will fully occupy the whole space of the cavity and will be combined with the TR;
taking out the shoe sole: separating the upper and the lower portions of the mould from each other to take out the shoe sole, cooling it down and trimming periphery of the shoe sole, thus a finished sole is obtained.
